(19) United States
(12) Patent Application Publication
(10) Pub. No.: US 2017/0067626 A1
(43) Pub. Date: Mar. 9, 2017

(54) LIGHT SOURCE MODULE

(71) Applicant: Koito Manufacturing Co., Ltd., Tokyo (JP)

(72) Inventors: Noriaki Ito, Shizuoka-shi (Shizuoka) (JP); Takuya Serita, Shizuoka-shi (Shizuoka) (JP); Atsushi Ozawa, Shizuoka-shi (Shizuoka) (JP); Tomiharu Hirano, Shizuoka-shi (Shizuoka) (JP)

(21) Appl. No.: 15/249,904

(22) Filed: Aug. 29, 2016

(30) Foreign Application Priority Data
Sep. 8, 2015 (JP) 2015-176235

(51) Int. Cl. F21V 23/06; F21V 29/70; F21S 8/10; F21V 23/00

(52) U.S. Cl. CPC F21V 23/06; F21V 23/006; F21V 29/70; F21S 48/1109; F21S 48/212; F21Y 2115/10

(57) ABSTRACT

A light source module of the present disclosure is provided with a light source, e.g., LED chips and a control circuit to control light emission of the light source. The light source module includes a light source mounting unit to be mounted with the light source, and a control mounting unit to be mounted with the control circuit. The light source mounting unit and the control mounting unit are formed as independent components that can be integrated with each other so that when the light source mounting unit and the control mounting unit are integrated with each other, the light source and the control circuit are electrically connected to each other.

### CROSS-REFERENCE TO RELATED APPLICATIONS

This application is based on and claims priority from Japanese Patent Application No. 2015-176235, filed on Sep. 8, 2015, with the Japan Patent Office, the disclosure of which is incorporated herein in its entirety by reference.

### TECHNICAL FIELD

The present disclosure relates to a light source module used for a lighting device (e.g., a lamp), in particular, a light source module suitable for a case where a light emitting element such as, for example, a light emitting diode (LED) is used as a light source.

### BACKGROUND

A lamp used for a vehicle such as, for example, an automobile is provided with a light source module configured by a light emitting element (e.g., an LED) as a light source. For example, Japanese Laid-Open Patent Publication No. 2003-212039 suggests, instead of a bulb mounted in a socket, an LED assembly which may be mounted in the socket. In addition, Japanese Laid-Open Patent Publication No. 2004-063084 suggests an LED light source in which an LED, a control circuit, and a socket are integrally formed. Since either the LED assembly or the LED light source is configured such that the LED as a light source (light emitter) and the lighting circuit (control circuit) enabling the LED to emit light are integrally formed, it is possible to turn on the LED assembly or the LED light source simply by connecting the LED assembly or the LED light source to an external power source such as, for example, an in-vehicle battery.

### SUMMARY

In the LED assembly of Japanese Laid-Open Patent Publication No. 2003-212039, the LED is mounted in a member serving as a base, and the control circuit of the LED is integrally installed in the base. Accordingly, it is concerned that heat generated from an electronic component constituting the control circuit, in particular, a current limiting resistance is transferred directly to the LED through the member serving as a base, thereby deteriorating the light emission characteristic of the LED. In the LED light source of Japanese Laid-Open Patent Publication No. 2004-063084, the LED and the control circuit are independently mounted in a member serving as a socket. However, since the LED and the control circuit are directly connected to each other in the state of being mounted in the socket member, the heat generated from the control circuit may also be easily transferred to the LED.

Meanwhile, Japanese Laid-Open Patent Publication No. 2006-313676 adopts a configuration in which the LED and the control circuit are provided separately from each other and electrically connected to each other by an electric cord to turn on the LED. Thus, the configuration is effective in suppressing the heat generated in the control circuit from being transferred to the LED, but requires that the LED and the control circuit be independently assembled in the lamp and connected to each other by the electric cord, thereby causing inconvenience in handling, as compared to the single-configuration light source structures of Japanese Laid-Open Patent Publication Nos. 2003-212039 and 2004-063084.

An object of the present disclosure is to provide a light source module which suppresses heat transfer from a control circuit to a light source (e.g., an LED) and enables the assembly work of the light source in a lighting device to be facilitated.

The present disclosure provides a light source module includes: a light source; a control circuit configured to control light emission of the light source; a light source mounting unit mounted with the light source thereon; a control mounting unit mounted with the control circuit. The light source mounting unit and the control mounting unit are formed as independent components that are configured to be integrated with each other, and the light source and the control circuit are electrically connected to each other when the light source mounting unit and the control mounting unit are integrated with each other. The light source mounting unit and the control mounting unit are formed as independent components that are configured to be integrated with each other, and the light source and the control circuit are electrically connected to each other when the light source mounting unit and the control mounting unit are integrated with each other.

In the present disclosure, the control circuit includes an electronic component having a relatively large caloric value during the light emission of the light source, as compared to that of the light source. In addition, the control circuit is constructed in a control substrate, and the control mounting unit is configured to be replaced with another control substrate.

In the present disclosure, the light source mounting unit or the control mounting unit is configured to be attachable/detachable with respect to a component of the lighting device. In addition, the control mounting unit is configured such that an external power source is connected thereto.

According to the present disclosure, since the light source and the control circuit are mounted on the light source mounting unit and the control mounting unit, which are separated from each other, respectively, the heat generated in the control circuit when the light source emits light is dissipated before the heat is transferred to the light source so that the heat is suppressed from being transferred to the light source. In addition, once any one side of the light source mounting unit and the control mounting unit is mounted in the lighting device, the other side may be assembled to the lighting device merely by integrating the other side with the one side. Further, since the electric connection between the light source and the control circuit may be implemented by the integration, the assembly of the lighting device may be easily implemented.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a cross-sectional view illustrating a light source module of a first exemplary embodiment in a state where the light source module is mounted in a lamp.

FIG. 2 is a perspective view illustrating the light source module of the first exemplary embodiment in a disassembled state.

FIGS. 3A and 3B are cross-sectional views illustrating the light source module in the unintegrated and integrated states, respectively.

FIG. 4 is a perspective view illustrating a part of the light source module of the first exemplary embodiment in an enlarged scale.

FIG. 5 is a circuit diagram illustrating an exemplary circuit configuration of the light source module.

FIG. 6 is a cross-sectional view illustrating a light source module of a second exemplary embodiment.

FIG. 7 is a perspective view illustrating a light source module of a third exemplary embodiment in a disassembled state.

FIG. 8 is a perspective view illustrating a light source module of a fourth exemplary embodiment in a disassembled state.

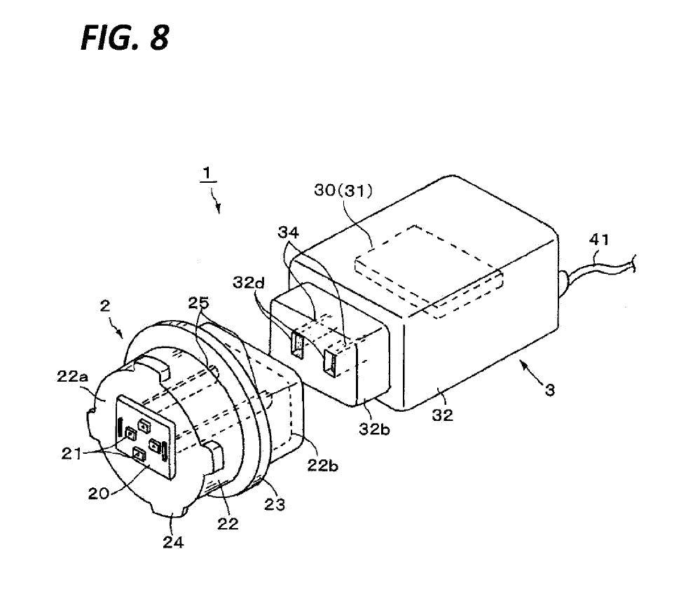

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

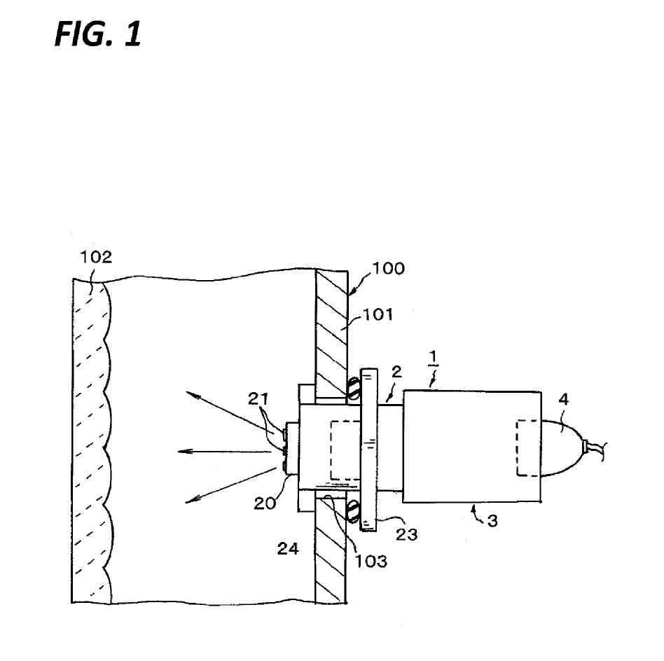

Next, exemplary embodiments of the present disclosure will be described with reference to the accompanying drawings. FIG. 1 is a cross-sectional view illustrating a part of a lamp mounted with a light source module 1 of a first exemplary embodiment of the present disclosure. Here, the lamp is configured as a marker lamp such as, for example, a tail lamp, and a lamp housing 100 is configured by a lamp body 101 and a front lens 102 such that the light source module 1 is mounted in a light source attachment hole 103 opened in the lamp body 101. The light source module 1 is configured to emit red light when the lamp is turned on, and a part of the red light emitted from the light source module 1 penetrates directly through the front lens 102 to be irradiated toward a predetermined direction outside an automobile.

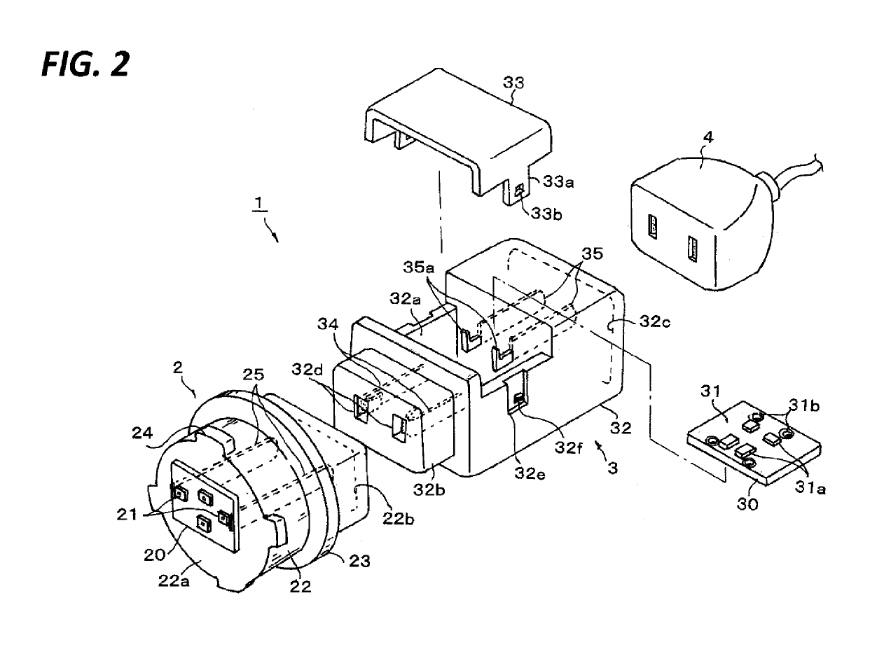

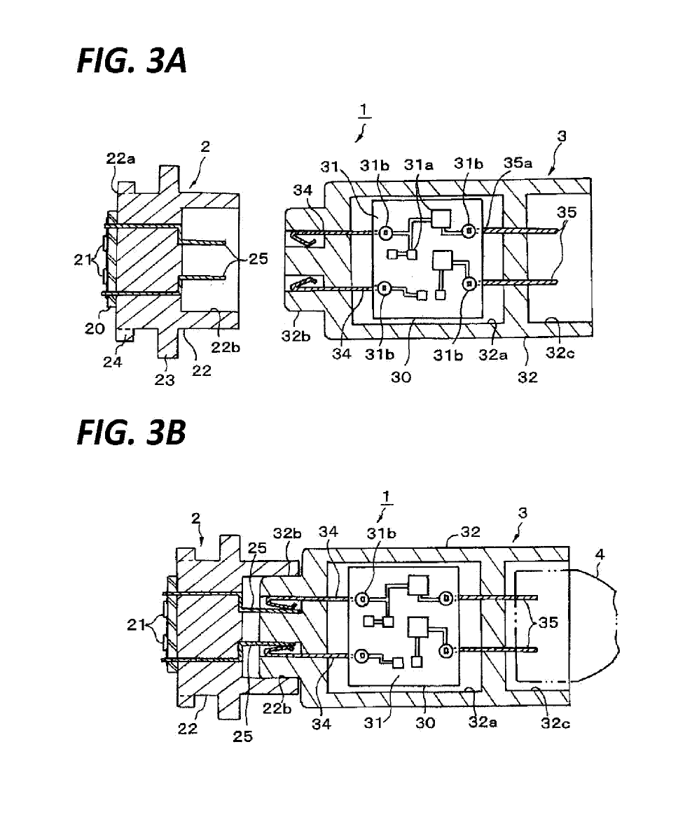

FIG. 2 is a perspective view illustrating the light source module 1 in a partially disassembled state. FIG. 3A is a cross-sectional view illustrating the light source module 1 when the light source module 1 is horizontally cut in a disassembled state. As illustrated in FIGS. 2 and 3A, the light source module 1 includes a light source mounting unit 2 and a control mounting unit 3. The light source mounting unit 2 and the control mounting unit 3 are formed as separate components, but configured to constitute one light source module 1 when they are engaged and integrated with each other. The light source mounting unit 2 is mounted with, here, a plurality of LED chips 21 as a light source. The control mounting unit 3 is mounted with a control circuit 31 that generates a control current to turn on the LED chips 21 (to cause the LED chips 21 to emit light). In addition, the control mounting unit 3 is configured such that an external power source connector 4 to be connected to an in-vehicle battery is connected to the control mounting unit 3.

The light source mounting unit 2 includes a light source base 22 formed by molding a resin. The light source base 22 has an external appearance formed in a short columnar shape. A circular flange 23 is formed on the peripheral surface of the light source base 22, and bayonet members 24 are provided to radially project at a plurality of positions on the circumference of the light source base 22. A bayonet structure is formed by the circular flange 23 and the bayonet members 24, and by the bayonet structure, the light source mounting unit 2 is configured to be attachable to/detachable from the light source attachment hole 103 of the lamp body 101.

The light source base 22 is configured such that one end surface thereof in the column axis direction (the left side in each of FIGS. 2 and 3A) serves as a light source mounting surface 22a. A recess 22b is formed to be concave in the column axis direction in the opposite side of the light source base 22 to the light source mounting surface 22a, and a required number of light source contacts 25 (here, two (2) light source contacts 25) are embedded in a state of extending in the area between the light source mounting surface 22a and the recess 22b. The light source contacts 25 are made of a strip-shaped conductive material such as, for example, metal, and formed by an integral molding to be integrated with the light source base 22. Each of the light source contacts 25 is exposed, at one end, to the light source mounting surface 22a, and projects, at the other end, into the recess 22b by a required length.

A light source substrate 20 mounted with the LED chips 21 is mounted on the light source mounting surface 22a of the light source base 22. Although not illustrated in the drawings, the light source substrate 20 includes an LED land and a connection land which are formed of a conductive film on the front and rear surfaces of a rectangular insulating substrate, and also includes a circuit pattern which electrically connects the LED land and the connection land to each other. In addition, an LED chip 21 is surface-mounted on each LED land. Here, four (4) LED chips 21 are mounted. In addition, the connection land is electrically connected to one end of each light source contact 25 by a brazing material such as, for example, solder. Accordingly, the LED chips 21 are electrically connected to the light source contacts 25 through the circuit pattern and the connection lands of the light source substrate 20.

The control mounting unit 3 is molded from a resin to have an external appearance close to a rectangular parallelepiped shape, and includes a control base 32 in a rectangular container form having a top-opened accommodation chamber 32a. In addition, the control mounting unit 3 includes a cover body 33 to cover the opening of the accommodation chamber 32a. On one side surface of the control base 32 in the longitudinal direction thereof, a protrusion 32b is formed to be engaged in the recess 22b provided in the light source mounting unit 2. On the other side surface of the control base 32, a recess 32c is formed to be concave in the longitudinal direction of the control base 32.

Two recessed holes 32d are formed on the tip end surface of the projecting portion 32b to allow the other ends of the light source contacts 25 to be engaged in the recessed holes 32d, respectively, and two strip-shaped conductive members 34 such as, for example, metal members extend to be embedded throughout the area from the recessed holes 32d to the accommodation chamber 32a. One end of each of the conductive members 34 is disposed inside each of the recessed holes 32d, and folded so as to serve as a pair of female contacts 34. In addition, two strip-shaped conductive members 35 such as, for example, metal members extend throughout the area from the recess 32c of the control base 32 to the accommodation chamber 32a. The tip ends of the conductive members 35 project into the recess 32c by a required length so as to serve as a pair of male contacts 35.

A control substrate 30 is housed in the accommodation chamber 32a of the control base 32. The control substrate 30 includes a control circuit 31 to cause the LED chips 21 to emit light, and a plurality of electronic components 31a such as, for example, resistances, a diode, and capacitors are mounted on a circuit pattern formed in the control substrate 30. In addition, through holes 31b are formed at four positions on the control substrate 30, here, positions close to the four corners, to penetrate from the front surface of the substrate through the rear surface thereof and to be electrically connected to the circuit pattern.

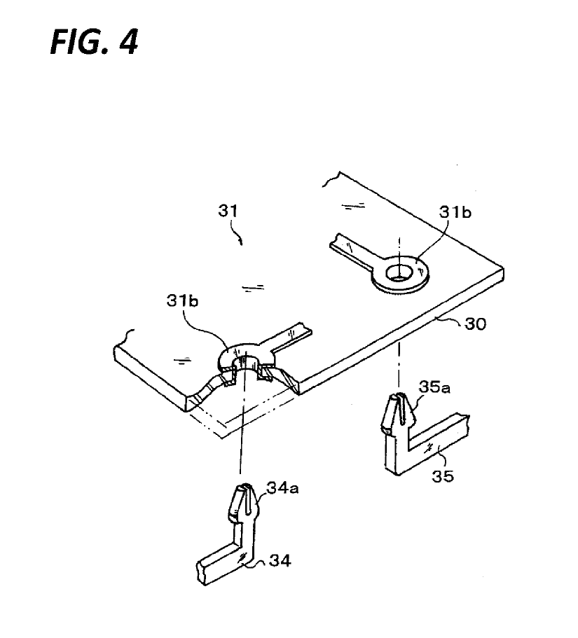

The control substrate 30 is housed in the accommodation chamber 32a through the opening of the control base 32. As illustrated in the perspective view FIG. 4 illustrating a part of each of the control substrate 30, the female contacts 34, and the male contacts 35 in an enlarged scale, the ends 34a and 35a of the female contacts 34 and the male contacts 35 that extend toward the inside of the accommodation chamber 32a are processed to be almost vertically bent toward the opening direction of the accommodation chamber 32a, and further processed to have a tapered arrowhead shape with a slot formed therein as so-called press-fit terminals.

Accordingly, when the control substrate 30 is housed in the accommodation chamber 32a through the opening, the press-fit terminals 34a and 35a of the female contacts 34 and the male contacts 35 are inserted into the through holes 31b, respectively, at the four positions on the control substrate 30 to be brought into a state of being inserted into each other. Accordingly, the control substrate 30 is fixedly supported in the inside the accommodation chamber 32a, and the control circuit 31 is electrically connected to each of the female contacts 34 and the male contacts 35. The connection structure provided by the press-fit terminals 34a and 35a enables an easy connection, as compared to a case where the control substrate 30 is electrically connected to each of the contacts 34 and 35 through electric wires, and requires no space for installation of the electric wires so that the connection structure may be configured in a small size.

The cover body 33 of the control mounting unit 3 is configured as a substantially U-shaped plate member to close the opening of the accommodation chamber 32a, and engagement pawl pieces 33a each having an engagement hole 33b are formed to project at the opposite sides of the cover body 33. When the cover body 33 is mounted on the control base 32 to close the accommodation chamber 32a, the engagement pawl members 33a are engaged with the engagement recesses 32e provided on the opposite side surfaces of the control base 32, and engagement pawls 32f provided on the engagement recesses 32e are engaged in the connection holes 33b. In this way, the cover body 33 closes the opening of the control base 32 so that the control substrate 30 housed in the accommodation chamber 32a is kept in a sealed state.

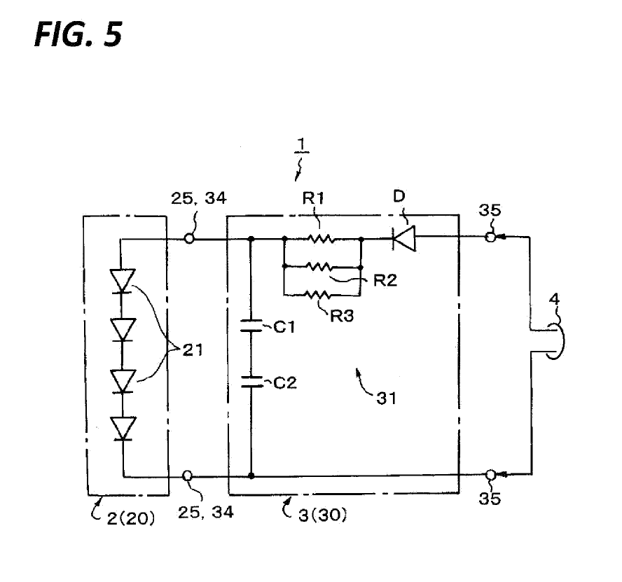

FIG. 5 is a circuit diagram of the control circuit 31 included in the control substrate 30. The four LED chips 21 are connected in series to each other, and the opposite ends of the serially connected LED chips 21 are connected to the light source contacts 25. The control circuit 31 is constituted with current limiting resistances R1 to R3, a protection diode D, and capacitors C1 and C2, and the current limiting resistances R1 to R3 and the protection diode D are connected in series to the LED chips 21 via the light source contacts 25 and the female contacts 34. In addition, the power supply side of the control circuit 31 is connected to the male contacts 35.

In the light source module 1 of the first exemplary embodiment configured as described above, the light source mounting unit 2 is mounted to the light source attachment hole 103 of the lamp body 101 by using the bayonet structure provided in the light source base 22 as illustrated in FIG. 1. In addition, as illustrated in FIG. 3B, the control mounting unit 3 is inserted into the light source mounting unit 2 to be integrated therewith. In this integration, the protrusion 32b of the control base 32 is inserted into the recess 22b of the light source mounting unit 2. By this insertion, the female contacts 34 of the control mounting unit 3 come in elastic contact with and the light source contacts 25 of the light source mounting unit 2 so that the female contacts 34 and the light source contacts 25 are electrically connected to each other. Thus, the control substrate 30 and the light source substrate 20 are electrically connected to each other, and as illustrated in FIG. 5, the LED chips 21 are electrically connected to the control circuit 31.

Further, when the external power source connector 4 connected to an in-vehicle battery is inserted into the recess 32c of the control base 32 of the control mounting unit 3, the male contacts 35 are electrically connected to contacts (not illustrated) of the external power source connector 4 so that the power of the in-vehicle battery is supplied to the control circuit 31. Accordingly, the power of the in-vehicle battery is supplied to the control circuit 31 of the control mounting unit 3 from the external power source connector 4 by an operation of a switch (not illustrated) provided in, for example, an automobile, and a required current is generated in the control circuit 31 so that the LED chips 21 are fed with power to emit light. As a result, the lamp is turned on.

According to the light source module 1, although heat is generated in the current limiting resistances R1 to R3 of the control circuit 31 when the LED chips 21 emit light, most of the heat is transferred from the control substrate 30 constructing the control circuit 31 to the control base 32 and dissipated in the control base 32, in particular, from the surface of the control base 32. Further, the heat is partially transferred to the light source mounting unit 2 through the female contacts 34 and the light source contacts 25. However, when the heat is transferred through the light source contacts 25, the heat is transferred to the light source base 22 and dissipated from the surface thereof. Accordingly, the heat is hardly transferred to the light source substrate 20 or the LED chips 21, thereby suppressing a deterioration of the light emission characteristic of the LED chips 21 due to the temperature increase of the LED chips 21.

In addition, when the light source module 1 is assembled into the lamp, the light source mounting unit 2 may be mounted in the lamp body 101, and then, the control mounting unit 3 may be inserted into the light source mounting unit 2 to be integrated therewith, as illustrated in FIG. 1. Alternatively, the control mounting unit 3 may be first inserted into the light source mounting unit 2 to be integrated therewith, and then, the light source mounting unit 2 may be mounted in the lamp body 101. Accordingly, an electric connection work to LED using an electric cord as in Patent Document 3 is unnecessary, and the assembly work of the light source module into the lamp may be easily conducted.

In addition, the light source module 1 may be freely combined with the light source mounting unit 2 and the control mounting unit 3. That is, a light source mounting unit 2, which is mounted with LED chips 21 with different characteristics or the different number of LED chips 21, may be integrated with another control substrate 30, i.e., a control mounting unit 3, which is constituted with a different control circuit 31, so as to construct one light source module. Accordingly, in a case where LED chips 21 of an identical light source mounting unit 2 are intended to emit light with different light intensities or in different light emission forms, or a protection element of the control circuit 31 is replaced with an element having a different characteristic to correspond to different specifications of LED chips 21, a control mounting unit 3 having a control circuit 31 suitable for each of the LED chips may be adopted and integrated with the light source mounting unit 2 so that the light emission with the different light intensities or in the different light emission forms may be implemented, and a highly reliable light source module may be implemented.

In this case, in the light source module 1 of the first exemplary embodiment, only the control substrate 30 of the control mounting unit 3 may be replaced. As described above, the control substrate 30 is housed and supported in the accommodation chamber 32a of the control base 32 by the engagement between the press-fit terminals 34a and 35a and the through holes 31b, and at the same time, electrically connected to the contacts 34 and 35. Accordingly, the control substrate 30 may be easily replaced with another control substrate by lifting up the control substrate 30 to release the engagement with the press-fit terminals 34a and 35a.

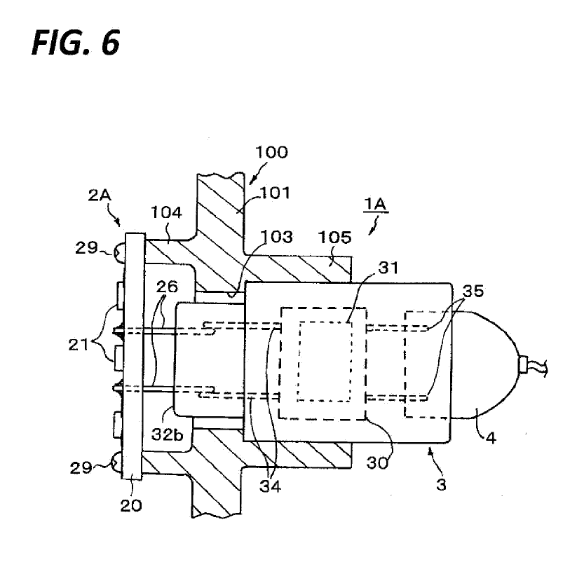

FIG. 6 is a cross-sectional view of a light source module 1A of a second exemplary embodiment, and components equivalent to those of the light source module 1 of the first exemplary embodiment will be denoted by the same reference numerals. The light source mounting unit 2A of the second exemplary embodiment is different from that of the first exemplary embodiment, but the configuration of the control mounting unit 3 in the second exemplary embodiment is identical to that in the first exemplary embodiment. The light source mounting unit 2A is configured by only the light source substrate 20 mounted with the LED chips 21 thereon, and does not include the light source base 22 of the first exemplary embodiment.

In the light source substrate 20 of the light source mounting unit 2A, an LED land, a connection land, and a circuit pattern electrically connecting the LED land and the connection land to each other, which are made of a conductive film, are formed on the front and rear surfaces of a rectangular insulating substrate that is larger than that of the first exemplary embodiment. The LED chips 21 are surface-mounted on the LED lands, respectively, and light source contacts 26 formed of two strip-shaped conductive members are provided on the connection lands, respectively, to be erected vertically with respect to the front and rear surfaces of the light source substrate 20. The tip ends of the light source contacts 26 are directed toward the rear surface direction of the light source substrate 20, and the base ends thereof are fixed and connected to the connection lands by, for example, solder.

Meanwhile, a plurality of bosses 104 are formed to integrally project forward on parts of the inner surface of the lamp body 101 in which the light source module 1 is to be mounted. The light source substrate 20 is fixedly supported to the bosses 104 by screws 29. In addition, the tip ends of the light source contacts 26 are installed to project outward through a light source attachment hole 103 formed to penetrate through a part of the lamp body 101.

A cylindrical portion 105 is formed on the outer surface of the lamp body 101 to integrally project rearward and surround the light source attachment hole 103. The cylindrical portion 105 is configured that the control base 32 of the control mounting unit 3 is inserted into the cylindrical portion 105. The control mounting unit 3 is provided with female contacts 34 as in the first exemplary embodiment, and configured that the female contacts 34 come in elastic contact with the tip ends of the light source contacts 26 of the light source mounting unit 2A to be electrically connected thereto.

In the light source module 1A of the second exemplary embodiment, the light source mounting unit 2A is in advance fixedly supported inside the lamp body 101, and the control mounting unit 3 is inserted into the cylindrical portion 105 of the lamp body 101 from the outside. When the control mounting unit 3 is inserted into the cylindrical portion 105, the protrusion 32b of the control mounting unit 3 is inserted into the light source attachment hole 103, and connected to the tip ends of the light source contacts 26 that extend to the inside of the light source attachment hole 103. Accordingly, the female contacts 34 of the control mounting unit 3 are electrically connected to the light source contacts 26, and the control circuit 31 of the control mounting unit 3 is electrically connected to the LED chips 21. Thus, as in the first exemplary embodiment, power is fed to the LED chips 21 of the light source mounting unit 2A through the control mounting unit 3 so that the LED chips 21 emit light.

In the light source module 1A of the second exemplary embodiment as well, the control circuit 31 housed in the control mounting unit 3 and the LED chips 21 of the light source mounting unit 2A are spaced apart from each other, and connected to each other through the female contacts 34 and the light source contacts 26. Thus, the heat generated in the control circuit 31 is dissipated from the control base 32 or dissipated in the lamp body 101 during the heat transfer to the light source mounting unit 2A so that the temperature increase of the LED chips 21 is suppressed.

In addition, in the light source module 1A of the second exemplary embodiment, the light source mounting unit 2A is fixedly supported inside the lamp body 101 when the lamp housing 100 is assembled. Thus, the light source module 1A may be fabricated by assembling only the control mounting unit 3 into the assembled lamp. In addition, in the light source module 1A of the second exemplary embodiment, the light source mounting unit 2A is merely configured such that the LED chips 21 are mounted on the light source substrate 20, and the light source contacts 26 are vertically erected thereon. Hence, the light source module 1A has a simple structure and may be configured in a small size.

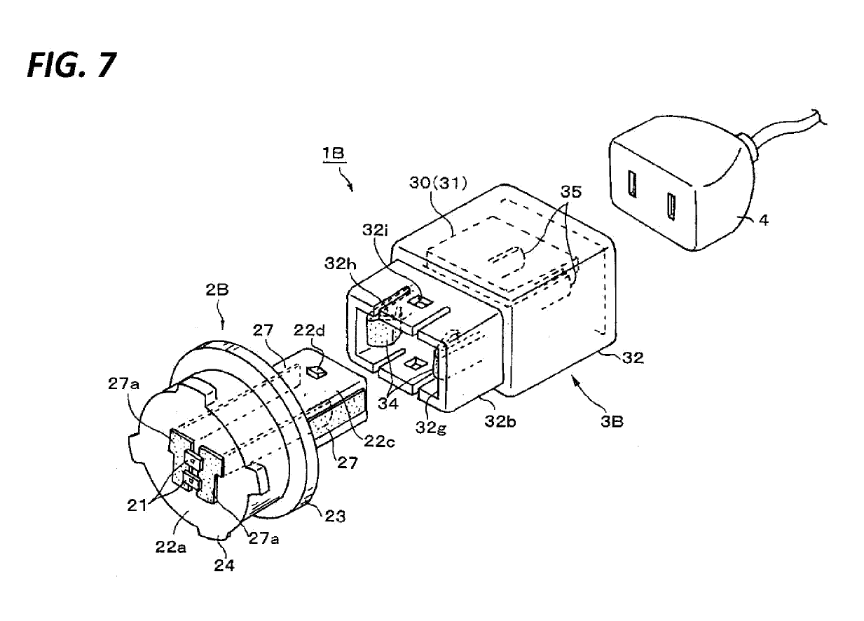

The above-described first and second exemplary embodiments are examples of the present disclosure, and the present disclosure may be configured as an exemplary embodiment to be described hereinafter. FIG. 7 is a cross-sectional view of a light source module 1B of a third exemplary embodiment. The light source mounting unit 2B includes lead frames 27 formed by processing metal plates, and the lead frames 27 are integrally molded in the resin-made light source base 22. Although the light source base 22 of the third exemplary embodiment is identical to the light source base of the first exemplary embodiment in that the bayonet structure is installed on the outer surface of the light source base 22, they are different from each other in that in the third exemplary embodiment, a rectangular column shaped protrusion 22c is formed to integrally project at the other end of the light source base 22.

The lead frames 27 are processed substantially in a U shape, and a mounting member 27a provided in the center of the U-shaped lead frames 27 is disposed and installed on the light source mounting surface 22a of the light source base 22. The mounting member 27a is mounted with two LED chips 21, and electrically connected to the lead frames 27. As light source contacts, the lead frames 27, in a state of being exposed along the opposite sides of the protrusion 22c, extends along the direction in which the protrusion 22c is installed to project.

As in the first and second exemplary embodiments, the control mounting unit 3B accommodates therein the control substrate 30 constituting the control circuit 31. In addition, the appearance shape of the control mounting unit 3B is also identical to that in the first and second exemplary embodiments. However, in the third exemplary embodiment, a recess 32g is provided concavely on the end surface of the protrusion 32b of the control base 32 so that the protrusion 22c of the light source base 2B may be inserted into the recess 32g. In addition, one end of each of the female contacts 34 integrally molded in the control base 32 of the control mounting unit 3B is disposed inside the recess 32g, and folded to have a slight elastic contact force as in the first exemplary embodiment.

In addition, engagement pawls 22d are integrally formed on the side surfaces of the protrusion 22c of the light source mounting unit 2B where the light source contacts 27 are not present, i.e., the top and bottom surfaces of the protrusion 22c in FIG. 7. In addition, engagement pieces 32h provided with elasticity by cut slits are formed in the top and bottom wall portions of the control mounting unit 3B corresponding to the recess 32g. The engagement pieces 32h are provided with engagement holes 32i which are opened to be engaged with the engagement pawls 22d.

In the light source module 1B of the third exemplary embodiment, when the light source mounting unit 2B and the control mounting unit 3B are integrated with each other, the protrusion 22c of the light source mounting unit 2B is inserted into the recess 32g of the control mounting unit 3B. When the protrusion 22c is inserted, the light source contacts 27 extending on the opposite sides of the protrusion 22c come in elastic contact with the female contacts 34 of the control mounting unit 3B to be electrically connected thereto. In addition, since the engagement pawls 22d of the protrusion 22c are engaged in the engagement holes 32i of the engagement pieces 32h facing the recess 32g, the integrated state of the light source mounting unit 2B and the control mounting unit 3B is firmly maintained, and the adhesion of the two components is improved.

In the light source module 1B of the third exemplary embodiment, the heat generated in the control circuit 31 of the control mounting unit 3B is transferred from the female contacts 34 and the male contacts 35 to the control base 32, and dissipated from the external surface of the control base 32. Further, the heat transferred to the light source contacts 27 through the female contacts 34 is transferred to the light source base 22, and dissipated from the external surface of the light source base 22. Since the female contacts 34 and the male contacts 35 are integrally molded in the control base 32, and the light source contacts 27 are integrally molded in the light source base 22, the adhesion between the contacts 27, 34, and 35 and the bases 22 and 32 is excellent, and the heat transfer performance from each of the contacts 27, 34, and 35 to each of the bases 22 and 32 is improved so that the dissipation effect may be increased.

Here, in the present disclosure, the control mounting unit may not be configured to make the external power source connector 4 attachable thereto/detachable therefrom. Accordingly, for example, in the case of the light source module 1 of the first exemplary embodiment, an electric cord 41 connected to an external power source (e.g., an in-vehicle battery) may be connected directly to the control mounting unit 3. In this case, the male contacts 35 provided in the control mounting unit 3 are not required, and the external connector 4 is not also required, so that simplification of the structure is further implemented.

In each of the above-described exemplary embodiments, the light source mounting unit is mounted with only the light source, i.e., the LED chips, but any other electronic component may be mounted in the light source mounting unit as long as the component exhibits a relatively small caloric value at the light emission time of the LEDs, as compared to those of other electronic components, and does not thermally affect the LEDs. Especially, even in the case where the control substrate mounted in the control mounting unit is replaced, when there is a common electronic component required to cause the LED chips to emit light, and the caloric value of the electronic component is small, the electronic component may be mounted in the control mounting unit so that the number of the electronic components of the control substrate is reduced, thereby, implementing further downsizing.

Each of the above-described exemplary embodiments presents an example where the surface-mounting type LED chips are used as a light source. However, bullet-type LEDs or chip-on-board type LEDs may be used. Further, light emitters other than LEDs may be used. In addition, while an example where the light source module is used for a light source of a marker lamp (e.g., a tail lamp) has been presented, the light source module may be used for a light source of other lamps such as, for example, a head lamp or an auxiliary lamp.

Since the light source module of the present disclosure may be configured such that the light source mounting unit and the control mounting unit are attachably/detachably integrated with each other, the control mounting unit may be attached to the lamp. For example, the bayonet structure may be installed in the control mounting unit to enable the control mounting unit to be mounted into the lamp, and the light source mounting unit is integrated with the light source mounting unit.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A light source module comprising:
a light source;
a control circuit configured to control light emission of the light source;
a light source mounting unit mounted with the light source thereon;
a control mounting unit mounted with the control circuit,
wherein the light source mounting unit and the control mounting unit are formed as independent components that are configured to be integrated with each other, and the light source and the control circuit are electrically connected to each other when the light source mounting unit and the control mounting unit are integrated with each other.

2. The light source module of claim 1, wherein the control circuit includes an electronic component having a relatively large caloric value during the light emission of the light source, as compared to that of the light source.

3. The light source module of claim 1, wherein the control circuit is constructed in a control substrate, and the control mounting unit is configured to be replaced with another control substrate.

4. The light source module of claim 2, wherein the control circuit is constructed in a control substrate, and the control mounting unit is configured to be replaced with another control substrate.

5. The light source module of claim 1, wherein the light source mounting unit or the control mounting unit is configured to be attachable/detachable with respect to a component of a lighting device.

6. The light source module of claim 2, wherein the light source mounting unit or the control mounting unit is configured to be attachable/detachable with respect to a component of a lighting device.

7. The light source module of claim 3, wherein the light source mounting unit or the control mounting unit is configured to be attachable/detachable with respect to a component of a lighting device.

8. The light source module of claim 4, wherein the light source mounting unit or the control mounting unit is configured to be attachable/detachable with respect to a component of a lighting device.

9. The light source module of claim 1, wherein the control mounting unit is configured such that an external power source is connected thereto.
